(19) United States
(12) Patent Application Publication
(10) Pub. No.: US 2011/0126795 A1
(43) Pub. Date: Jun. 2, 2011

(54) OLIVE-SHAPED ROTARY ENGINE

(75) Inventor: Feng Hua, Shandong Province (CN)

(73) Assignee: SHANGDONG ICD HIGH PERFORMANCE FIBRES CO., LTD., Laiwu, Shandong (CN)

(21) Appl. No.: 12/991,123

(22) PCT Filed: Apr. 30, 2009
(86) PCT No.: PCT/CN09/00477

§ 371 Date: Jan. 24, 2011

(30) Foreign Application Priority Data
May 7, 2008 (CN) 200810015978.X

(51) Int. Cl. F01C 1/356; F02B 53/04; F01C 17/02

(52) U.S. Cl. 123/245

(57) ABSTRACT

This invention involves internal combustion engine, especially the olive-shaped rotary engine. The olive-shaped rotary engine not only overcomes the defects of large reciprocating inertia the existing piston reciprocating engine has, complex structure and large volume but also overcomes the defects of small output torque the existing rotary internal combustion engine has, the fuel not being able to fully combust and high manufacturing process requirements. If the fuel can't be fully combusted, it will lead to a higher amount of fuels. This invention consists of crankshaft, shell and triangle rotor. Within centre hole of the triangle rotor is equipped with connecting handle, which is connected with crankshaft through gear set. The shuttle-like moving path when the rotor of the connecting handle is connected with the centre of the crankshaft results from the driving of the gear set, realizing the basic working process of the internal combustion engine. The internal combustion engine is of simple structure, small volume and light weight. In addition, it operates stably, produces small vibration, improves output torque and makes fuel fully combust. It's of wide range of available fuels and minor mechanical wear.

### CROSS-REFERENCE TO RELATED APPLICATIONS

The present application claims the benefit of International Application No. PCT/CN2009/000477, for which this application hereby enters the U.S. National Stage under 35 USC 371.

### BACKGROUND OF THE INVENTION

1. Field of the Invention

This invention relates to internal combustion engines, especially an olive-shaped rotary engine.

2. Description of Related Art

Currently piston reciprocating engines are commonly used in automobiles. A piston reciprocating engine drives a piston's reciprocating and rectilinear motion by combusting in a combustion chamber. Then the piston's reciprocating motion is converted to a crankshaft's rotary motion through a connecting rod and the crankshaft, thus driving gearing's output. The piston reciprocating engines have large reciprocating inertia, complex structure and large volume. To solve these problems, Wankel, a German engineer, invented the rotary internal combustion engine in 1950s. The rotary internal combustion engine can directly convert the heat energy that is given off after the combustion and expansion of the fuel and air to the mechanical energy that drives the rotation of the rotor. Then the rotor drives the principal shaft to put out energy. As it cancels the rectilinear motion, the rotary internal combustion engine of the same power has simpler structure, smaller volume, lighter weight, and lower vibration and noise. Even though it has many advantages, the rotary internal combustion engine is not widely used because the shape of its combustion chamber can't make the fuel fully combust. Besides, the path of the flame propagation is long, increasing the loss of the fuel oil. In addition, the rotary internal combustion engine can only be ignited by spark ignition and can't be ignited by compression ignition, so it can't use diesel fuel. Furthermore, the rotary internal combustion engine has small output torque and its structure has high requirements for the lubrication of the engine, cooling and sealing. Therefore it has high manufacturing process requirements. Because of these reasons, the rotary internal combustion engine can't be widely used.

### BRIEF SUMMARY

This invention aims at overcoming the above defects the existing piston engine and rotary internal combustion engine have, and providing a new-type olive-shaped rotary engine. The olive-shaped rotary engine is of simple structure, small volume and light weight. In addition, it operates stably, reduces vibration, improves output torque and makes fuel fully combust. It can use a wide range of the available fuels and has minor mechanical wear.

This invention is realized by the following technical solutions. The olive-shaped rotary engine comprises a crankshaft, a shell and a triangle rotor. The shell mould cavity is olive-shaped and both ends are covered with end caps. The triangle rotor is placed in the olive-shaped mould cavity. The mould cavity curve and hollows of the triangle rotor are of the same breadth, and the shaft line of the principal shaft of the crankshaft is coincident with the center of the mould cavity. The rotor is connected with the crankshaft through a connecting handle. The cylinder on the connecting handle is the rotor's connecting shaft, which is placed at the center hole of the triangle rotor. Its shaft line is coincident with the center line of the rotor. The rotor's connecting shaft is sleeved on a crankpin through its eccentric orifice. The connector on one side of the rotor's connecting shaft is equipped with a gear set, which is used to control the rotation of the connecting handle. The crankshaft rotates when the gear set drives the connecting handle to rotate, thus making the moving path of the center of the rotor's connecting shaft a shuttle-like path.

Assume the crank radius of the crankshaft is R. Then the distance between the rotor's connecting shaft and the shaft line of the crankpin is \sqrt{3} R, and the shuttle-like moving path is an arc line crossed by two circles with the distance from their centers of 2\sqrt{3}(13+\sqrt{3})R and a radius of 2(1+\sqrt{3})R.

Assume an outer corner between a connecting line that connects the center of the crankpin with the center of the principal shaft of the crankshaft and the major shaft of the shell is α. And the outer corner between a connecting line that connects the center of the rotor's connecting shaft with the center of the crankpin and a connecting line that connects the center of the crankpin with the center of the principal shaft of the crankshaft is β. The relationship of the two angles is:

When 0°≦α≦180°, tan(β/2)=0.5×tan(90−α)×{(3−\sqrt{3})+\sqrt{(2−\sqrt{3})×[2+4/(1+sin α)]}}

When 180°≦α≦360°, tan(β/2)=0.5×tan(90−α)×{(3−\sqrt{3})+\sqrt{(2−\sqrt{3})×[2+4/(1−sin α)]}}

The gear set in this invention comprises the following gears. A connecting handle's gear is fixed on the connector on one side of the rotor's connecting shaft. This gear is sleeved on the crankpin and is coaxial with the crankpin. Another gear is fixed on the shell. The gear is sleeved on the principal shaft of the crankshaft. Its center is coincident with the rotation center of the crankshaft. The rotary shaft of two coaxial idle pulleys is placed on the gear carrier of the crankshaft and is meshed with the shell's fixed gear and the connecting handle's gear respectively.

According to the above relationship of angles and the transmission gear ratio between the gears meshed with each other in the gear set, the crankshaft is reverse rotary with the connecting handle and the transmission gear ratio between the connecting handle and the crankshaft is:

### When 0°≦α≦180°,

$$2 \times \frac{( 3 - \sqrt{3} + \sqrt{( 2 - \sqrt{3} )} \times [ \begin{matrix}\sqrt{( 2 + 4 / ( 1 + sin α )} + \\ \frac{sin ( 2 \times α ) \times cos α}{\sqrt{{( 1 + sin α )}^{2} \times 2 + 4 / ( 1 + sin α )}}\end{matrix} ]}{2 \times {( Sin α )}^{2} + 0.5 \times {[ ( cos α ) \times [ \begin{matrix}( 3 - \sqrt{3} ) + \\ \sqrt{( 2 - \sqrt{3} ) ( 2 + 4 / ( 1 + sin α ) )}\end{matrix} ] ]}^{2}}$$

Because the cycle of α is 180°, when 180°≦α≦360°, it's acceptable to substitute α−180°.

Two sets of air inlets and air outlets are placed on the shell, symmetrically on the hollows near two top ends of the olive-shaped mould cavity, of which the air inlet is close to the olive-shaped top end. A combustion chamber is placed at the air outlet or air inlet. The shape of the combustion chamber depends on the mode of the combustion. The compression ratio of the engine depends on the volume of the combustion chamber. According to the requirements of different fuels, the sides are equipped with either spark plug or oil sprayer. The internal surface of the olive-shaped shell is equipped with air press channel which is close to the combustion chamber, The air press channel can be single-channel or multi-channels, The air press chambers which are formed when the rotor is rotating is connected with the combustion chamber through the air press channel. Grooves are placed respectively in the middle of two cambered surfaces of the olive-shaped shell, and a sealing strip is placed in each of the grooves. The sealing strip clings to the rotor through a leaf spring in the groove. The surface of the sealing strip facing the triangle rotor is double hollows which are applicable to the arc curve of the rotor with the larger radius and the arc curve of the rotor with the smaller radius respectively. Both ends of the rotor are covered with triangle arc sealing strips. They are placed in the groove near the end's edge of the rotor. The leaf spring is placed in the groove to make the sealing strips cling to the end cap of the shell. The side of the end cap facing the rotor can be inserted with ceramic plates, which can reduce the heat loss when the rotor rotates because of its good thermo insulating property. A balancing plate is fixed on the connecting handle and it's used to balance the rotor's engine.

The cambered surface of the triangle rotor is a closed camber line, which is formed by three 60° arcs with a larger radius being crossed with three 60° arcs with a smaller radius. The mould cavity of the olive-shaped shell is a closed camber line, which is formed by two 120° arcs with a larger radius being crossed with two 120° arcs with smaller radius. The smaller radius is r=(0.5˜3) R, and the larger radius is R′=2(3+\sqrt{3})R+r.

The invention has the following advantages. This engine is of small volume, light weight, large output torque under the same working volume, good accelerating ability and low working noise. Compared with piston reciprocating engines, it's of simpler structure, less operating parts and more stable operation. Compared with the existing triangle rotary internal combustion engines, the shape of the combustion chamber according to the present invention can make the fuel fully combust and use diesel oil as the fuel. In addition, when the explosive power is at its maximum, there's generally no torque output for piston reciprocating engines and rotary internal combustion engines; but there's torque output for the engines according to the present invention. Compared with the existing engines, the torque output maximum has been greatly improved. The rotating speed of the crankshaft according to the present invention is slower than that of the triangle rotary internal combustion engines, so it can not only reduce the loss of the engine's parts but also reduce the requirements for lubrication and sealing. All in all, whether it's under a high rotating speed or under a low rotating speed, the torque output of the engine according to the present invention is larger. It overcomes the defect of smaller torque output when the triangle rotary internal combustion engine operates under a low rotating speed, thus reducing the consumption of the fuels.

### BRIEF DESCRIPTION OF THE DRAWINGS

FIG. 1 is a structural diagram of the olive-shaped rotary engine.

FIG. 2 is a structural diagram of the crankshaft.

FIG. 3 is a structural diagram of the connecting handle.

FIG. 4 shows a shuttle-like moving path of the shaft line of the rotor's connecting shaft.

FIG. 5 shows a contour of the rotor.

FIG. 6 shows a contour of the olive-shaped shell.

FIG. 7 is a structural diagram of the engine.

FIG. 8 shows the shape of a combustion chamber according to a first embodiment of the present invention.

FIG. 9 shows the shape of a combustion chamber according to a second embodiment of the present invention.

FIG. 10 shows the shape of a combustion chamber according to a third embodiment of the present invention.

FIG. 11 shows the shape of a combustion chamber according to a fourth embodiment of the present invention.

FIG. 12 shows the operating state of the combustion chamber according to the first embodiment of the present invention.

FIG. 13 shows a valve structure according to one embodiment of the present invention.

FIG. 14 is a structural diagram of the sealing and lubrication of the rotor's arc.

FIG. 15 is a structural diagram of the sealing and lubrication of the rotor's end.

FIG. 16 shows a working diagram when the center of the rotor is at the top dead center.

FIG. 17 shows a working diagram when an upper working chamber takes in air and a lower working chamber combusts.

FIG. 18 shows a working diagram when the center of the rotor is at the bottom dead center and a lower working chamber is under power.

FIG. 19 shows a working diagram when the upper working chamber combusts and the lower working chamber is under power.

FIG. 20 shows a working diagram when the center of the rotor is at the top dead center and the upper working chamber combusts.

FIG. 21 shows a working diagram when the upper working chamber is under power and the lower working chamber discharges air.

FIG. 22 shows a working diagram when the center of the rotor is at the bottom dead center.

FIG. 23 shows a working diagram when the upper working chamber discharges air and the lower working chamber takes in air.

### DETAILED DESCRIPTION OF THE EMBODIMENTS

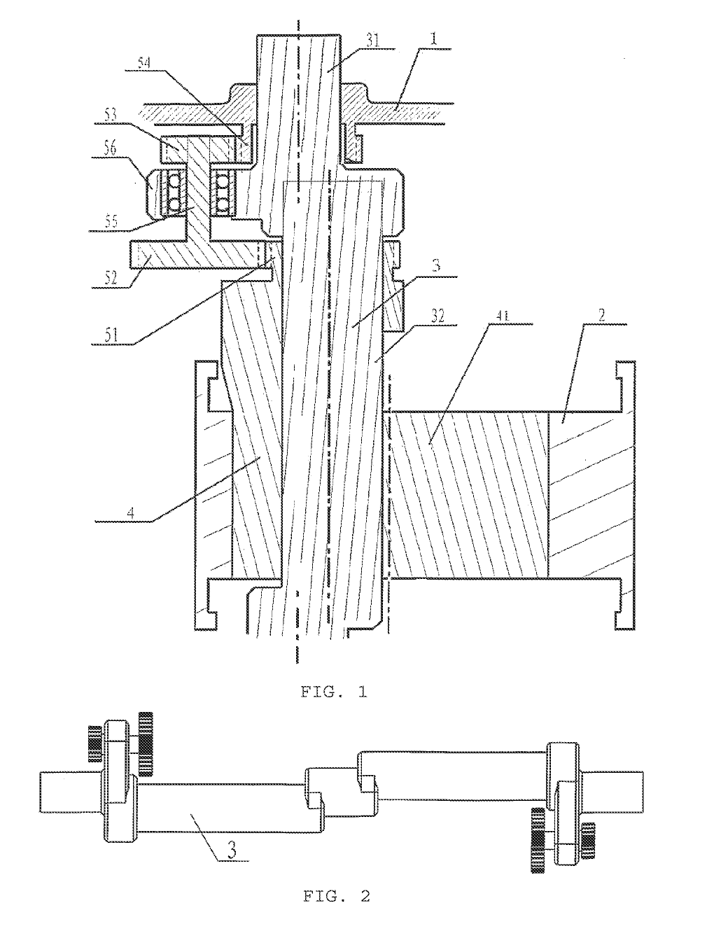

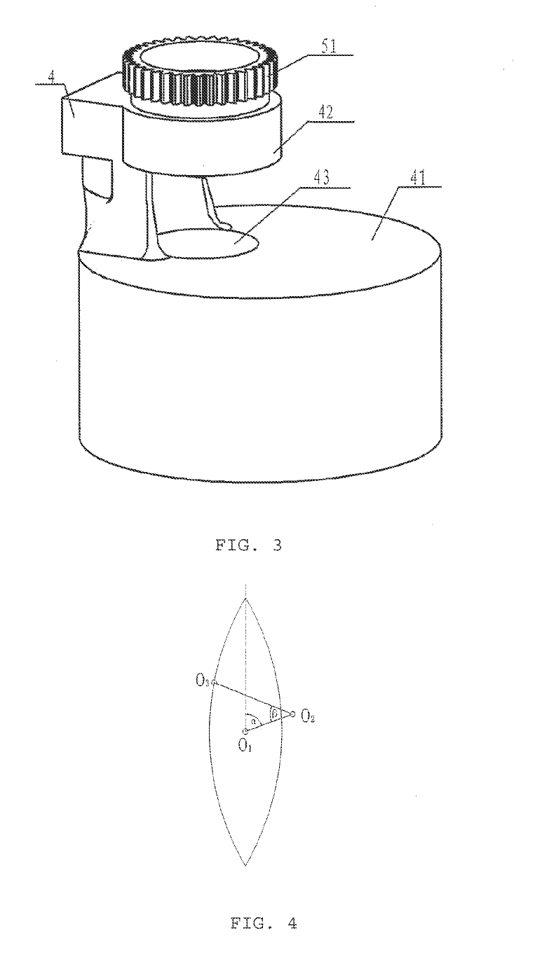

An embodiment of the invention is a birotary engine. The birotary engine has compact structure and stable operation, being equivalent to piston reciprocating four cylinder engine. The structure of its crankshaft is shown in FIG. 2. As shown in FIG. 1, the engine comprises the crankshaft 3, a shell 1, a connecting handle 4, a gear set and a triangle rotor 2. The mould cavity of the shell 1 is olive-shaped. Both ends are covered by end caps 17. The triangle rotor 2 is placed in the mould cavity. The mould cavity curve and the hollows of the triangle rotor are of the same breadth. This engine controls the center of the rotor to follow a shuttle-like moving path by the operating mechanism comprising the crankshaft 3, the connecting handle 4 and the gear set. The contact between the inner wall of the olive-shaped shell and the outer edge of the rotor limits the rotation of the rotor 2. When the rotor moves in the shell, it divides the space in the shell and makes the space of two working chambers change continually. Each of the working chambers has an air inlet, an air outlet and a combustion chamber, which are placed on the hollows near the two ends of the olive-shaped shell. With the cooperation of a controlling valve in a valve mechanism, the two working chambers can realize the basic working process of the internal combustion engine respectively.

As is shown in the drawings, the crankshaft 3 is placed at the center of the mould cavity of the olive-shaped shell, that is, its shaft line is coincident with the center line of the mould cavity. The connecting handle 4 is the connector between the rotor 2 and the crankshaft 3. Its cylinder is the rotor's connecting shaft 41, which is placed in the center hole of the rotor 2. Its shaft line is coincident with the center line of the rotor. The rotor's connecting shaft 41 is sleeved on a crankpin 32 through its eccentric orifice. Assume the radius of the crankshaft is R. The eccentric orifice between the rotor's connecting shaft 41 and the shaft line of the crankpin 32 is \sqrt{3} R. A connector 42 on one side of the rotor's connecting shaft 41 is equipped with the gear set, which is the driving mechanism used to control the rotation of the connecting handle 4. When the principal shaft 31 of the crankshaft rotates, the gear set drives the connecting handle 4 to rotate, making the shaft line of the rotor's connecting shaft 41 of the connecting handle 4 move along a shuttle-like moving path, that is, the shuttle-like moving path is the arc line crossed by two circles with the distance between their centers of 2\sqrt{3}(1+\sqrt{3})R and a radius of 2(1+\sqrt{3})R, as shown in FIG. 4.

The above gear set comprises the following four gears: a gear fixed on the connecting handle 4, that is, the connecting handle's gear 51 which is sleeved on the crankpin 32 and is coaxial with the crankpin 32; a gear fixed on the shell 1, that is, the shell's fixed gear 54 which is sleeved on the principal shaft 31 of the crankshaft and is coaxial with the principal shaft 31 of the crankshaft; and coaxial idle pulleys 52 and 53 meshed with the connecting handle's gear 51 and the shell's fixed gear 54 respectively and with their rotary shaft 55 placed on the gear carrier 56. The shell's fixed gear 54 and the idle pulley 53 are common circular gear and have a transmission ratio of 2; and the idle pulley 52 and the connecting handle's gear 51 are gears with special shape and have the following transmission ratio:

$$\frac{( 3 - \sqrt{3} + \sqrt{2 - \sqrt{3}} ) \times [ \begin{matrix}\sqrt{2 + 4 / ( 1 + sin \frac{α}{2} )} + \\ \frac{sin α \times cos ( \frac{α}{2} )}{\sqrt{\begin{matrix}1 + 2 {sin}^{2} ( \frac{α}{2} ) + \\ \frac{4}{1 + sin \frac{α}{2}}\end{matrix}}}\end{matrix} ]}{2 \times {sin}^{2} ( \frac{α}{2} ) + 0.5 \times {[ \begin{matrix}cos \frac{α}{2} \times ( 3 - \sqrt{3} + \\ \sqrt{\begin{matrix}( 2 - \sqrt{3} ) \times \\ ( 2 + \frac{4}{1 + sin \frac{α}{2}} )\end{matrix}}\end{matrix} ]}^{2}}$$

As shown in FIG. 4, assume the outer corner between the connecting line 0₁0₂ and the principal shaft of the shell is α, wherein 0₁0₂ connects the center 0₂ of the crankpin with the center 0₁ of the principal shaft of the crankshaft. And assume the outer corner between the connecting line 0₂0₃ and the connecting line 0₁0₂ is β, wherein 0₂0₃ connects the center 0₃ of the rotor's connecting shaft with the center 0₂ of the crankpin and 0₁0₂ connects the center 0₂ of the crankpin with the center 0₁ of the principal shaft of the crankshaft. The relationship of the two angles is:

When 0°≦α≦180°, tan(β/2)=0.5×tan(90−α)×{(3−\sqrt{3})+\sqrt{(2−\sqrt{3})×[2+4/(1+sin α)]}}

When 180°≦α≦360°, tan(β/2)=0.5×tan(90−α)×{(3−\sqrt{3})+\sqrt{(2−\sqrt{3})×[2+4/(1−sin α)]}}

According to the above relationship of the angles, the crankshaft 3 is reverse rotary with the connecting handle 4. According to the transmission ratio of the gear set, the rotating speed of the connecting handle 4=the rotating speed of the crankshaft 3×

$$2 \times \frac{( 3 - \sqrt{3} + \sqrt{( 2 - \sqrt{3} )} \times [ \begin{matrix}\sqrt{( 2 + 4 / ( 1 + sin α )} + \\ \frac{sin ( 2 \times α ) \times cos α}{\sqrt{{( 1 + sin α )}^{2} \times 2 + 4 / ( 1 + sin α )}}\end{matrix} ]}{2 \times {( Sin α )}^{2} + 0.5 \times {[ ( cos α ) \times [ \begin{matrix}( 3 - \sqrt{3} ) + \\ \sqrt{( 2 - \sqrt{3} ) ( 2 + 4 / ( 1 + sin α ) )}\end{matrix} ] ]}^{2}}$$

$$2 \times \frac{( 3 - \sqrt{3} + \sqrt{( 2 - \sqrt{3} )} \times [ \begin{matrix}\sqrt{( 2 + 4 / ( 1 + sin α )} + \\ \frac{sin ( 2 \times α ) \times cos α}{\sqrt{{( 1 + sin α )}^{2} \times 2 + 4 / ( 1 + sin α )}}\end{matrix} ]}{2 \times {( Sin α )}^{2} + 0.5 \times {[ ( cos α ) \times [ \begin{matrix}( 3 - \sqrt{3} ) + \\ \sqrt{( 2 - \sqrt{3} ) ( 2 + 4 / ( 1 + sin α ) )}\end{matrix} ] ]}^{2}}$$

When 0°≦α≦180°, the above formula is applicable; when 180°≦α≦360°, it's acceptable to substitute α−180°. According to the above formula, the rotating speed of the connecting handle 4 is about twice of the rotating speed of the crankshaft 3.

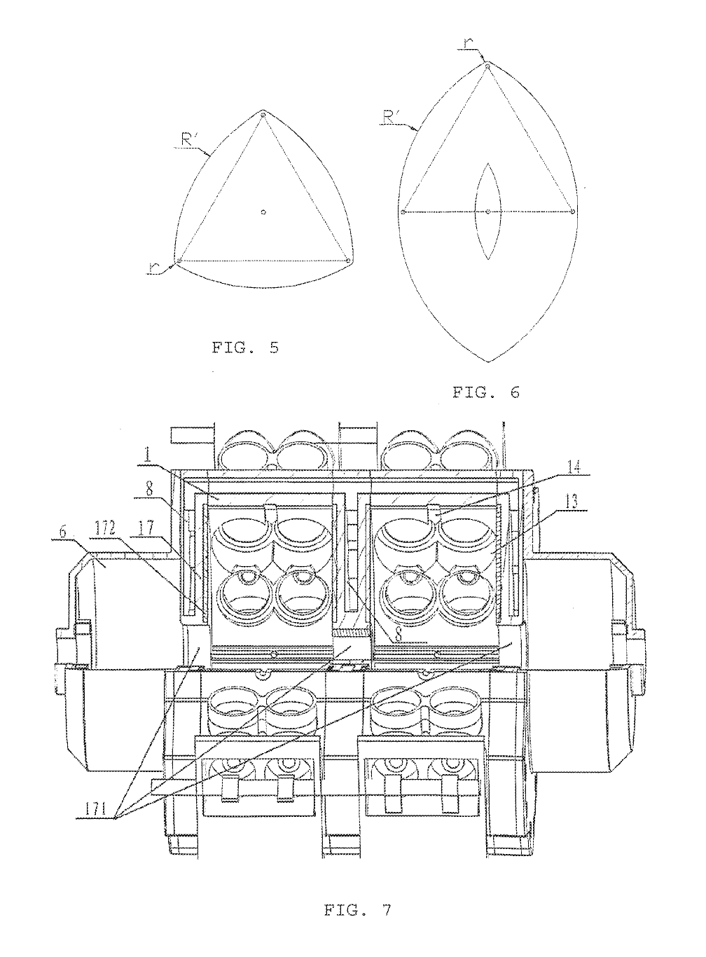

As shown in FIG. 5, the external surface curve of the triangle rotor 2 is a closed curve, which is formed by three 60° arcs with a larger radius being crossed with three 60° arcs with a smaller radius. The smaller radius is r=1.5R, and the larger radius is R′=2(3+\sqrt{3})R+r. As shown in FIG. 6, the internal surface curve of the mould cavity of the olive-shaped shell 1 is a closed curve, which is formed by two 120° arcs with a larger radius being crossed with two 60° arcs with a smaller radius. Because this curve corresponds to the external surface of the rotor 2, its smaller radius and larger radius are equal to the smaller radius and the larger radius of the triangle rotor 2 respectively.

As shown in FIG. 7, the shell of the engine comprises a shell 6 at each of the two ends and the olive-shaped shell 1 that is used to install the engine of the rotor. A torque output device is placed in the shell 6 at each of the two ends respectively. Each of the two ends of the olive-shaped shell 1 is equipped with an end cap 17, on which is fixed the center hole of the end cap that is used to install the crankshaft 3. The side of the end cap 17 towards the rotor can be inserted with a ceramic plate 172, which has wear resistant property and long service life and can reduce the heat loss when the rotor rotates because of its good thermo insulating property. The space between the two end caps 17 of two adjacent olive-shaped shells 1 is hollow. It's used to install a water channel 8. In addition, in the space between the shell 6 on both ends and the end cap 17 of the shell is equipped with the water channel 8.

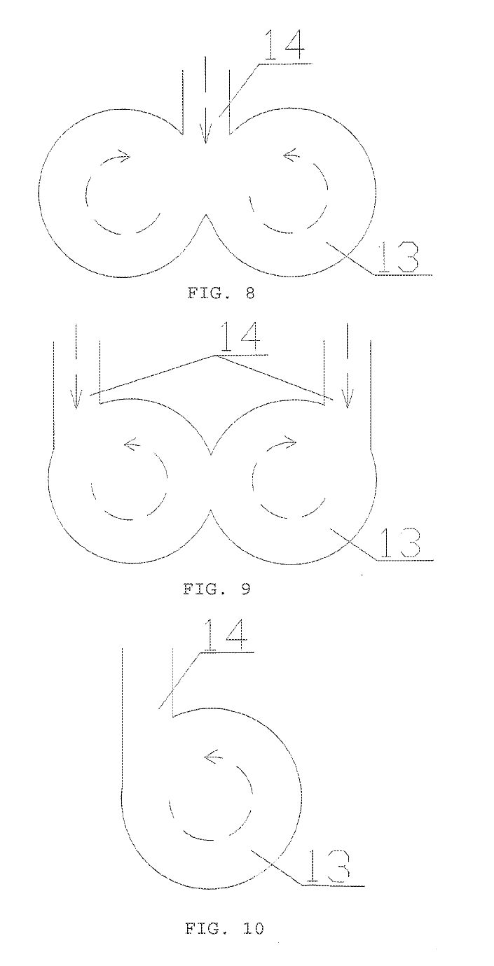

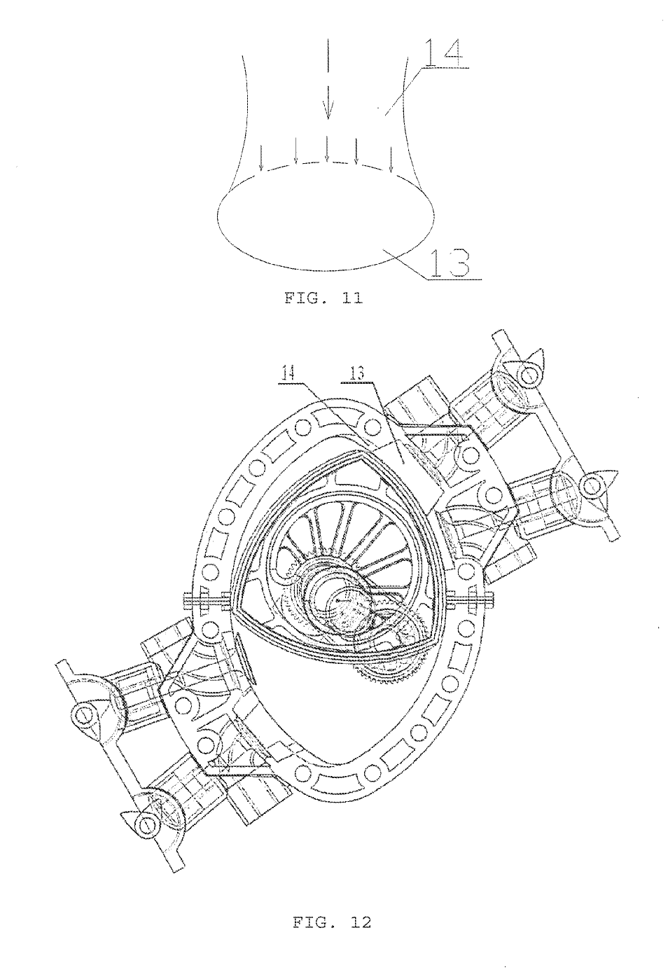

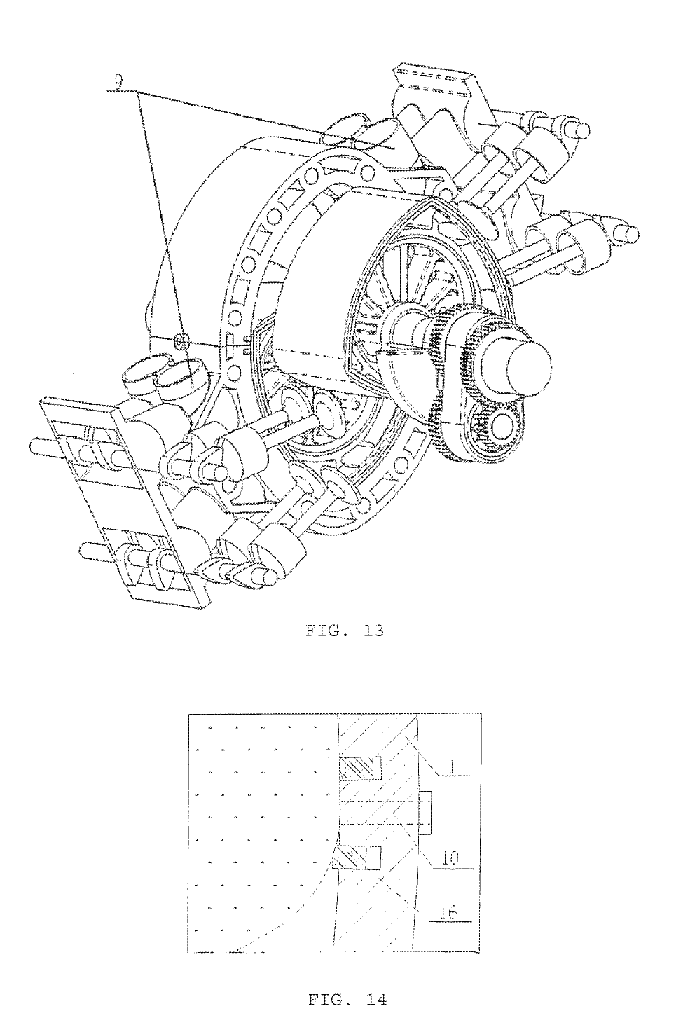

The triangle rotor 2 divides the shell 1 into two working chambers, every working chamber is equipped with air inlet 11 and air outlet 12. The air inlet 11 and the air outlet 12 are close to top ends of olive-shaped shell, and the air outlet 12 is equipped with the combustion chamber 13. The internal surface which is close to the combustion chamber 13 is equipped with groove which is used as the air press channel 14. When the rotor rotates and compresses, the air pressing chamber is formed in the inner chamber of the shell, the air in the air press chamber is compressed into the air press channel 14, and entered into the combustion chamber 13. According to the different kind of the fuels, the combustion mode can be swirl combustion, turbulent flow combustion, or mixed combustion. The combustion chamber which is used for the swirl combustion is single or double swirl chamber. As is shown by FIG. 8 and FIG. 12, the combustion chamber 13 is double-swirl chamber, the combustion chamber 13 is a circular space where two circles are crossed with each other. At the place where two circles are crossed with each other is equipped with an air press channel 14 that is connected with the air inlet 11. When the rotor 2 compresses the air, air press chambers are formed in the inner chamber of the shell, the pressed air is compressed into the combustion chamber 13 through the air press channel 14. Under the effect of pressure difference, the air in the air press channel 14 forms air flow. When the air flow enters the combustion chamber 13, it forms eddy flow. As is shown by FIG. 9, the combustion chamber 13 is double-swirl chamber, and both sides of the combustion chamber are equipped with the air press channel 14 which is both-side air press channel. As is shown by FIG. 10, the combustion chamber 13 is single-swirl chamber, one side of the combustion chamber is equipped with air press channel 14 which is single-side air press channel. The eddy flow can be formed from the air after it is entered the combustion chamber 13 through above air press channel 14. The combustion chamber 13 which is shown in the FIG. 11 is turbulent flow combustion chamber, the turbulent flow can be formed from the air when it is entered into the combustion chamber 13 through the air press channel 14 and the holes which is on the top surface of the combustion chamber 13. When different fuels are applied, the engine can work by changing the volume of the combustion chamber and changing the numbers of the parts used. For example, when the gas is applied, corresponding spark plugs should be added in the combustion chamber 13; when the diesel oil is applied, the fuel injection equipment should be added in the combustion chamber 13. The fuel injection equipment is equipped nearby the joining of the air press channel 14 and the combustion chamber 13, or is equipped in the internal surface of the combustion chamber 13. The valve mechanism 9 of this engine is shown by FIG. 13. Its structure and working principle is similar to that of the piston reciprocating engine.

The balancing of this engine comprises two parts. First, this engine is a birotary engine. As shown in FIG. 2, dual rotors are placed on the crankshaft 3, so there are two crankpins on the crankshaft and the angle between the two crankpins is 180°, thus realizing the balancing of the crankshaft. In addition, a balancing plate is placed on the connecting handle of each of the two rotors and the angle between the balancing plates of the two connecting handles is 180°. By the two ways mentioned above, the balancing of the engine is realized.

The sealing of the triangle rotors includes cambered surface seal and the end face seal. The cambered surface seal is shown in FIG. 14. Two grooves are placed respectively in the middle of the two cambered surfaces of the olive-shaped shell 1 and a sealing strip 16 is placed in each of the grooves. The sealing strips 16 cling to the rotor 2 through a leaf spring in each of the grooves. The sealing strips 16 are double arc sealing strips, that is, the surface of the sealing strip 16 facing the triangle rotor has two hollows, which are applicable to the rotor's arc curve with the larger radius and the rotor's arc curve with smaller radius respectively, thus realizing the cambered surface seal. As is shown by FIG. 14, the groove is placed at both ends of the rotor 2 and near the end's edge of the rotor. The leaf spring and end sealing strip 21 are fixed in the groove. The end sealing strip 21 is a triangle arc strip, which clings to the end cap 17 through the leaf spring, thus realizing the end seal of the rotor 2. Because the sealing strip 16 is placed on the shell, it can be taken out of the groove of the shell directly when it is replaced and cleaned, instead of disassembling the engine.

The cooling system of this engine is shown in FIG. 7 and FIG. 15. A water channel 8 is placed between the shell 6 on both ends of the engine and the end cap 17 of the shell. A water channel 8 is also placed between the end caps 17 of two adjacent shells. The two water channels are connected through the water channel hole 15 on the olive-shaped shell 1 and are connected with water temperature cooling device through pipes, thus making the cooling fluid flow circularly and cooling the engine. At the same time, it can realize recycling of the cooling fluid. An oil tank is placed in the shell 6 on both ends. The lubricant in the oil tank can not only lubricate the ends of the rotor 2 through a center hole 171 of the end cap but also cool the rotor.

When the rotor 2 rotates in the olive-shaped shell 1, it should be lubricated in order to reduce the friction between the external surface of the rotor 1 and the cambered surface of the mould cavity and the end cap 17 of the shell. The lubrication includes rotor cambered surface lubrication and rotor end lubrication. The rotor cambered surface lubrication is shown in FIG. 15. The oil inlet and outlet 10 is placed between two grooves in the middle of the mould cavity of the olive-shaped shell, making the lubricant being sprayed regularly on the cambered surface of the rotor 2 and realizing the rotor cambered surface lubrication. At the same time the oil inlet and outlet 10 also has the effect of heat elimination and cooling. The rotor end lubrication can be realized by the lubricant in the oil tank of the shell 6 on both ends.

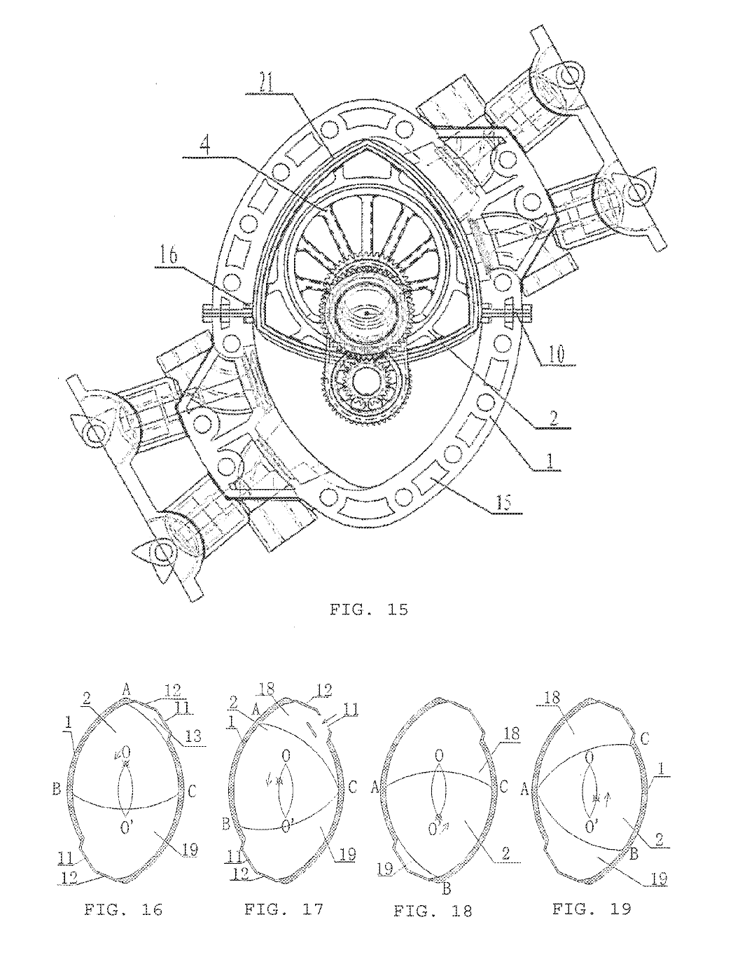

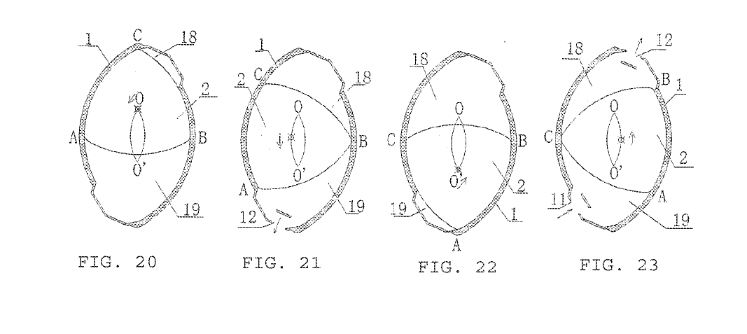

When the triangle rotor 2 rotates in the shell 1, it divides the space in the shell 1 into two parts, thus forming an upper working chamber and a lower working chamber. With the continual rotation of the rotor 2, the volumes of the two working chambers are changed continually. Two sets of air inlets 11, air outlets 12 and the combustion chamber 13 are placed on the hollows of the two ends of the olive-shaped shell 1. When a valve mechanism 9 controls the valve, the air inlet and air outlet are opened and closed, and the basic working process of the internal combustion engine is realized in the two working chambers respectively. The working process of the rotary engine is as follows. Firstly as shown in FIG. 16, when the center of the rotor 2 is at the top dead center 0, the volume of the upper working chamber 18 is at its minimum. At that time, the air outlet 12 is just closed, that is, the exhaust process is finished. The volume of the lower working chamber 19 is at its maximum. At that time, the air inlet 11 is just closed, that is, the air admission process is finished. There are two surfaces on the rotor 2 that are connected with the internal surface of the shell. As is shown by FIG. 17, when the rotor 2 rotates, the air inlet of the upper working chamber 18 is opened. The rotor 2 encircles its peak C and its center rotates along the shuttle-like moving path shown by the figure and compresses the air in the lower working chamber 19, thus finishing the compression in the lower working chamber 19. At the same time, the air inlet 11 of the upper working chamber 18 is opened and begins the air admission. When the rotor 2 rotates, there's always a surface that can be connected with the internal surface of the shell 1. As shown in FIG. 18, when the rotator 2 rotates tilt its center is at the bottom dead center 0′, the volume of the lower working chamber 19 is at its minimum. At that time the combustion is finished in the lower working chamber 19, and the air inlet 11 of the upper working chamber 18 is closed and the volume is at its maximum. There're two surfaces on the rotor 2 that are connected with the internal surface of the shell 1. During the process of combustion, the lower working chamber 19 can generate great pressure. Under the effect of the pressure, the rotor 2 continues to rotate encircling its peak A. As shown in FIG. 19, when the lower working chamber 19 makes power, the rotor 2 rotates while compressing the air in the upper working chamber 18, that is, the compression is not finished in the upper working chamber 18 until the center of the rotor is at the top dead center 0. As shown in FIG. 20, when the center of the rotor is at the top dead center 0, the volume of the upper working chamber 18 is compressed to its minimum, and the compressed fuel is ignited to finish the ignition operation. At the same time, great pressure is generated to push the rotor 2 to continue to rotate. As shown in FIG. 21, when the rotor 2 rotates encircling its peak B, that is, the power making in the upper working chamber 18 is finished. At the same time, the air outlet 12 of the lower working chamber 19 is opened and begins exhaust process. As shown in FIG. 22, when the center of the rotor 2 is at the bottom dead center 0′, the power making is finished in the upper working chamber 18 and the exhaust in the lower working chamber 19 is finished. The air outlet is closed. As shown in FIG. 23, when the rotor 2 goes on rotating encircling the peak C, the air inlet 11 of the lower working chamber 19 is opened and begins air admission. At the same time, the air outlet 12 of the upper working chamber 18 is opened and begins exhaust. The rotor works according to the above process. From the above process, it can be seen that when the center of the rotor rotates along the shuttle-like moving path for two circles, the upper working chamber and the lower working chamber finish a whole working process continually, including air admission, compression, combustion, power making, and exhaust. During the process of rotation, the triangle rotor 2 supplies the torque for the output shaft 31 by its eccentric distance from the crankpin 33 and the gear set 5. Meanwhile the crankpin 33 supplies certain torque for the output shaft 31 by its eccentric distance from the output shaft 31, thus improving the output torque of the output shaft.

The air outlet 12 in the figures is close to the olive-shaped shell's end. Besides, the location of the air inlet 11 and the air outlet 12 can be exchanged, i.e., placing the air inlet 11 close to the olive-shaped shell's end. When the air inlet 11 is close to the olive-shaped shell's end and the combustion chamber is at the bottom of the air outlet, the performance of the engine is better.

The gear set mentioned in this invention can be realized by installing externally tangent gears and other gear structure. The transmission ratio is not limited to the numbers in the embodiments. As long as they are of the same effect, they are acceptable. In addition, this engine can be configured as multiple rotary engines connected in series, thus making the output of the engine more stable.

1. An olive-shaped rotary engine, comprising: a crankshaft (3), a shell (1) and a triangle rotor (2), wherein a mould cavity of the shell is olive-shaped, end caps (17) are respectively placed on its two ends, the triangle rotor (2) is placed in the olive-shaped mould cavity, and the mould cavity curve is an arc with the same breath as hollows of the triangle rotor (2), and wherein: a shaft line of a principal shaft (31) of the crankshaft is coincident with the center of the mould cavity, the rotor (2) and the crankshaft (3) are connected through a connecting handle (4), a cylinder on the connecting handle (4) is a rotor's connecting handle (41) and is placed at a center hole of the rotor with its shaft line coincident with a center line of the rotor, the rotor's connecting shaft (41) is sleeved on a crankpin (32) by its eccentric orifice, a gear set is placed on a connector (42) on a side of the rotor's connecting handle (41) close to the crankshaft (3), and when the crankshaft (3) rotates, the connecting handle (4) is driven by the gear set, making the center of the rotor's connecting shaft (41) of the connecting handle (4) move along a shuttle-like moving path.

2. The olive-shaped rotary engine of claim 1, wherein when a crank radius of the crankshaft is R, a distance between the rotor's connecting shaft (41) and a shaft line of the crankpin (32) is \sqrt{3}R.

3. The olive-shaped rotary engine of claim 1, wherein the shuttle-like moving path is an arc line crossed by two circles with a distance from centers of the circles of 2\sqrt{3}(1+\sqrt{3})R and a radius of 2(1+\sqrt{3})R.

4. The olive-shaped rotary engine of claim 1, wherein an outer corner between a connecting line that connects the center of the crankpin with the center of the principal shaft of the crankshaft and the major shaft of the shell is α, the outer corner between a connecting line that connects the center of the rotor's connecting shaft with the center of the crankpin and a connecting line that connects the center of the crankpin with the center of the principal shaft of the crankshaft is β, and the relationship of the two angles is:
When 0°≦α≦180°, tan(β/2)=0.5×tan(90−α)×{(3−\sqrt{3})+\sqrt{(2−\sqrt{3})×[2+4/(1+sin α)]}}
When 180°≦α≦360°, tan(β/2)=0.5×tan(90−α)×{(3−\sqrt{3})+\sqrt{(2−\sqrt{3})×[2+4/(1−sin α)]}}

5. The olive-shaped rotary engine of claim 1, wherein the crankshaft (3) is reverse rotary with the connecting handle (4).

6. The olive-shaped rotary engine of claim 1, wherein the gear set comprises: a connecting handle's gear (51), a shell's fixed gear (54) and idle pulleys therebetween, wherein the connecting handle's gear (51) is fixed on the connector (42) of the connecting handle (4), is sleeved on the crankpin (32) and is coaxial with the crankpin (32); the shell's fixed gear (54) is sleeved on the principal shaft (31) of the crankshaft with its center coincident with the rotation center of the crankshaft; these two gears are connected through the coaxial idle pulleys; and the rotary shaft (55) of the two coaxial idle pulleys is placed on a gear carrier (56) and the two idle pulleys meshed with the shell's fixed gear (54) and the connecting handle's gear (51) respectively.
$$\frac{( 3 - \sqrt{3} + \sqrt{2 - \sqrt{3}} ) \times [ \begin{matrix}\sqrt{2 + 4 / ( 1 + sin \frac{α}{2} )} + \\ \frac{sin α \times cos ( \frac{α}{2} )}{\sqrt{\begin{matrix}1 + 2 {sin}^{2} ( \frac{α}{2} ) + \\ \frac{4}{1 + sin \frac{α}{2}}\end{matrix}}}\end{matrix} ]}{2 \times {sin}^{2} ( \frac{α}{2} ) + 0.5 \times {[ \begin{matrix}cos \frac{α}{2} \times ( 3 - \sqrt{3} + \\ \sqrt{\begin{matrix}( 2 - \sqrt{3} ) \times \\ ( 2 + \frac{4}{1 + sin \frac{α}{2}} )\end{matrix}}\end{matrix} ]}^{2}}$$

7. The olive-shaped rotary engine of claim 1, wherein a cambered surface of the triangle rotor is a closed camber line, which is formed by three 60° arcs with a larger radius being crossed with three 60° arcs with a smaller radius; wherein when a crank radius of the crankshaft is R, the smaller radius is r=(0.5˜3)R, the larger radius R′=2(3+\sqrt{3})R+r; and wherein the mould cavity of the olive-shaped shell is a closed camber line, which is formed by two 120° arcs with a larger radius being crossed with two 60° arcs with a smaller radius and the smaller radius and the larger radius are equal to the smaller radius and the larger radius of the triangle rotor respectively.

8. The olive-shaped rotary engine of claim 1, wherein the shell corresponding to each rotor has an air inlet and an air outlet placed symmetrically on the hollows near two top ends of the olive-shaped mould cavity, the air inlet is close to the olive-shaped top end, and a combustion chamber (13) is placed at the air outlet or the air inlet.

9. The olive-shaped rotary engine of claim 1, wherein a groove is placed on the internal surface of the olive-shaped shell and close to a combustion chamber, the groove is an air press channel, and air press chambers which are formed when the rotor is rotating are connected with the combustion chamber through the air press channel.

10. The olive-shaped rotary engine of claim 1, wherein grooves are placed respectively in the middle of two cambered surfaces of the mould cavity of the olive-shaped shell, a sealing strip (16) is placed in each of the grooves; the sealing strip (16) clings to the rotor through a leaf spring in the groove, and the surface of the sealing strip facing the triangle rotor is double hollows which are applicable to the rotor's arc curve with the larger radius and the rotor's arc curve with the smaller radius respectively.

11. The olive-shaped rotary engine of claim 1, wherein the side of the end cap (17) facing the rotor is inserted with ceramic plates (172).
